(19) United States
(12) Patent Application Publication
(10) Pub. No.: US 2005/0266816 A1
(43) Pub. Date: Dec. 1, 2005

(54) PLL synthesizer

(75) Inventor: Takashi Konno, Kariya-shi (JP)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Kabushiki Kaisha Toyota Jidoshokki, Kariya-shi (JP)

(21) Appl. No.: 11/136,665

(22) Filed: May 24, 2005

(30) Foreign Application Priority Data
May 25, 2004 (JP) 2004-154566

(51) Int. Cl. H04B 1/40; H04B 1/06; H04B 7/00

(52) U.S. Cl. 455/260; 455/76

(57) ABSTRACT

A phase detection circuit generates a phase error signal indicating the phase difference between a reference signal and a frequency division signal output from a frequency divider. A charging pump circuit generates a charging pump current depending on the phase error signal. A low pass filter generates a control voltage by smoothing the charging pump current. A VCO outputs a signal of the frequency depending on the control voltage. A frequency divider frequency-divides an output signal of the VCO according to a frequency division ratio indicator signal, and transmits the resultant signal to the phase detection circuit. A correction circuit corrects a charging pump current only when the difference between a control voltage and a target control voltage corresponding to the frequency division ratio indicator signal is larger than a predetermined value.

### BACKGROUND OF THE INVENTION

1. Field of the Invention

The present invention relates to a PLL synthesizer which generates a signal at a desired frequency.

2. Description of the Related Art

Conventionally, a PLL (phase locked loop) synthesizer for stably generating a signal at a desired frequency has been used for various uses. For example, it has been used in a radio receiver capable of receiving various frequencies, a communication device for communicating a radio signal while switching frequencies, etc.

FIG. 1 shows the configuration of a common PLL synthesizer. A PLL synthesizer 100 shown in FIG. 1 generates a signal at a desired frequency using a reference signal, and outputs the generated signal.

A phase detection circuit 101 detects a phase difference between a reference signal and a frequency divided signal output from a frequency divider 105, and generates phase error signals PDU and PDD proportional to the phase difference. The reference signal is a signal at a constant frequency generated by a crystal oscillator, etc. A charging pump circuit 102 generates a charging pump current depending on the phase error signals PDU and PDD. A low pass filter 103 generates a control voltage VT by smoothing the charging pump current generated by the charging pump circuit 102. Then, a voltage control oscillator (hereinafter referred to as a VCO) 104 outputs a signal at a frequency depending on the control voltage VT.

The frequency divider 105 is a programmable frequency divider, and frequency-divides an output signal of the VCO 104 according to an externally generated frequency division ratio indicator signal. By applying the output of the frequency divider 105 to the phase detection circuit 101. In the PLL synthesizer 100 with the above-mentioned configuration, when the frequency of the reference signal is “Fref” and the frequency division ratio of the frequency divider 105 is “N”, the PLL circuit operates such that the output signal of the VCO 104 is “N×Fref”.

The patent document 1 (Japanese Patent Laid-open Publication No. 11-251902) describes the technology of improving the carrier noise ratio by providing a unit for correcting the charging pump current such that a damping factor can be suppressed for each of the set frequencies in a stationary state with a locked PLL circuit in the above-mentioned configuration.

The patent document 2 (Japanese Patent Laid-open Publication No. 6-291646) describes the technology of configuring a charging pump unit by a plurality of charging pump circuits connected in parallel in a PLL circuit including a phase detection circuit, the charging pump unit, a low pass filter, and a VCO, and converging a phase error into zero in a short time by forcibly raising a charging pump current when it is necessary to lock up the PLL circuit at a high speed.

It is desired that a PLL synthesizer can quickly lock a phase loop in its initial operation (including the operation immediately after switching the output frequency). However, the patent document 1 does not describe any specific technique for it. Although the patent document 2 describes the technique of shortening the locking time by temporarily raising the charging pump current, no concrete method for it is disclosed, and the development of more effective or efficient method is required.

### SUMMARY OF THE INVENTION

The present invention aims at providing a PLL synthesizer for efficiently shortening the locking time of the PLL.

The PLL synthesizer according to the present invention includes: a voltage control oscillator for generating a signal at a frequency depending on a control voltage; a frequency divider for frequency-dividing an output signal of the voltage control oscillator according to a frequency division ratio indicator signal; a phase detection circuit for generating a phase error signal indicating the phase difference between a reference signal at a predetermined frequency and output of the frequency divider; a charging pump circuit for generating a charging pump current according to the phase error signal; a filter for generating the control voltage from the charging pump current; and a correction circuit for correcting the charging pump current based on the difference between the control voltage and a target control voltage depending on the frequency division ratio indicator signal.

Since the PLL synthesizer operates according to a frequency division ratio indicator signal such that the frequency of the signal which is obtained by frequency-dividing the output signal of the voltage control oscillator matches the frequency of the reference signal, the frequency of the output signal of the voltage control oscillator is designated by the frequency division ratio indicator signal. The frequency of the output signal of the voltage control oscillator uniquely depends on the control voltage. Therefore, according to the frequency division ratio indicator signal, the control voltage (target control voltage) with which the voltage control oscillator is to generate the frequency specified by the frequency division ratio indicator signal can be estimated. Then, based on the difference between the control voltage and the target control voltage, a charging pump current is corrected.

In the above-mentioned PLL synthesizer, the correction circuit can include: a voltage range setting unit for setting a predetermined voltage range including the target control voltage depending on the frequency division ratio indicator signal, a determination unit for determining whether or not the control voltage is within the voltage range; and a current generation unit for generating a correction current for correction of the charging pump current only when the control voltage is not within the voltage range.

With the above-mentioned configuration, a charging pump current is corrected if the difference between the actual control voltage and the target control voltage exceeds a predetermined value. That is, if the difference is smaller than the predetermined value, a charging pump current is not corrected.

In the PLL synthesizer, the voltage range setting unit can set a plurality of voltage ranges, and the current generation unit can generate a large current with an expanding voltage range. With this configuration, the charging pump current can be stepwise changed depending on the difference between the actual control voltage and the target control voltage.

A PLL synthesizer according to another aspect of the present invention includes: a voltage control oscillator for generating a signal at a frequency depending on a control voltage; a frequency divider for frequency-dividing an output signal of the voltage control oscillator according to a frequency division ratio indicator signal; a phase detection circuit for generating a phase error signal indicating the phase difference between a reference signal at a predetermined frequency and output of the frequency divider; a first charging pump circuit for generating a first charging pump current according to the phase error signal; a second charging pump circuit, provided parallel to the first charging pump circuit, for generating a second charging pump current smaller than the first charging pump current according to the phase error signal; a switch for selecting the first charging pump circuit when the control voltage is not within the voltage range including a target control voltage depending on the frequency division ratio indicator signal, and selecting the second charging pump circuit when the control voltage is within the voltage range; and a filter for generating the control voltage from a charging pump current generated by the charging pump circuit selected by the switch.

With the configuration, if the difference between the actual control voltage and the target control voltage is larger than a predetermined value, a large charging pump current (first charging pump current) is provided, and if the difference is smaller than the predetermined value, a small charging pump current (second charging pump current) is provided.

According to the present invention, if the difference between the actual control voltage and the target control voltage is larger than a predetermined value, a large charging pump current is generated, thereby shortening the locking time of the PLL. If the difference between the actual control voltage and the target control voltage is smaller than a predetermined value, a small charging pump current is generated, thereby stably operating the PLL.

### BRIEF DESCRIPTION OF THE DRAWINGS

FIG. 1 shows the configuration of an existing common PLL synthesizer.

FIG. 2 shows the configuration of the PLL synthesizer according to the embodiment of the present invention;

FIG. 3 shows an embodiment of a charging pump circuit;

FIG. 4 shows an embodiment of a correction circuit;

FIG. 5 shows another embodiment of a correction circuit; and

FIG. 6 shows an essential portion of the PLL synthesizer according to another embodiment of the present invention.

### DESCRIPTION OF THE PREFERRED EMBODIMENTS

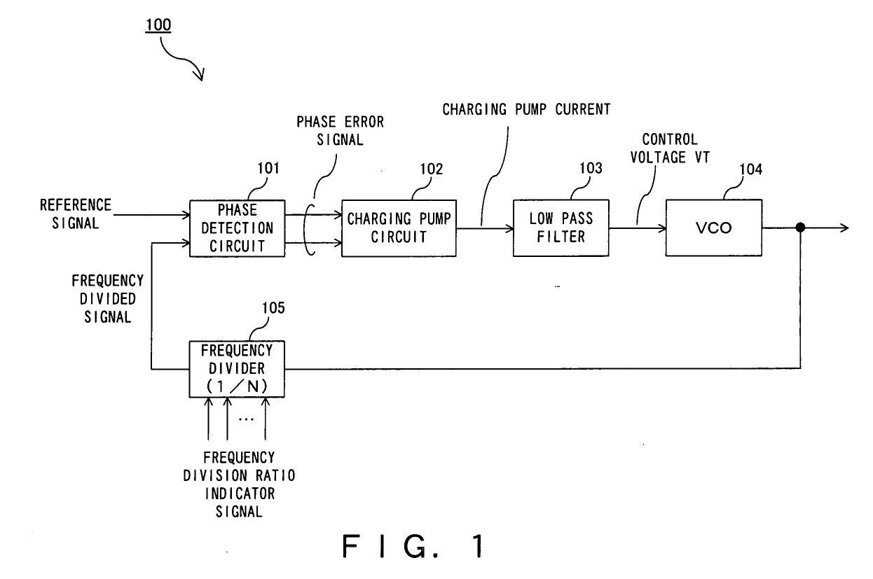

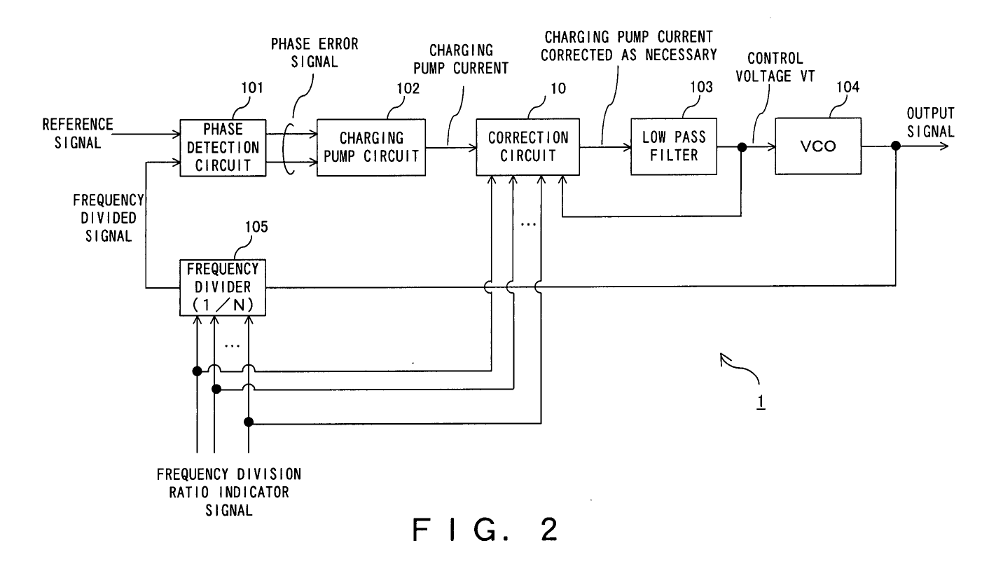

FIG. 2 shows the configuration of the PLL synthesizer according to the embodiments of the present invention. The reference numerals commonly used in FIGS. 1 and 2 refer to the same components. That is, the phase detection circuit 101, the charging pump circuit 102, the low pass filter 103, the VCO (voltage control oscillator) 104, and the frequency divider 105 are described above by referring to FIG. 1. In other words, a PLL synthesizer 1 according to an embodiment of the present invention can be realized by adding a correction circuit 10 to an existing synthesizer. However, the present invention is not limited to the configuration obtained by adding the correction circuit 10 to an existing synthesizer.

The correction circuit 10 corrects charging pump current generated by the charging pump circuit 102 according to the frequency division ratio indicator signal. The frequency division ratio indicator signal indicates the frequency division ratio used when the frequency divider 105 frequency-divides an output signal output by the VCO 104, and is provided by an external circuit not shown in the attached drawings or by a user operation.

In the PLL synthesizer 1 with the above-mentioned configuration, it is assumed that an output signal having a frequency N times the frequency Fref of the reference signal is generated. In this case, the digital data indicating “N” as a frequency division ratio indicator signal is provided for the PLL synthesizer 1. Then, the frequency divider 105 generates a frequency divided signal obtained by frequency-dividing by N the frequency Fout of the output signal output from the VCO 104. The phase detection circuit 101 generates a phase error signals PDU and PDD corresponding to the phase difference between the reference signal and the frequency divided signal.

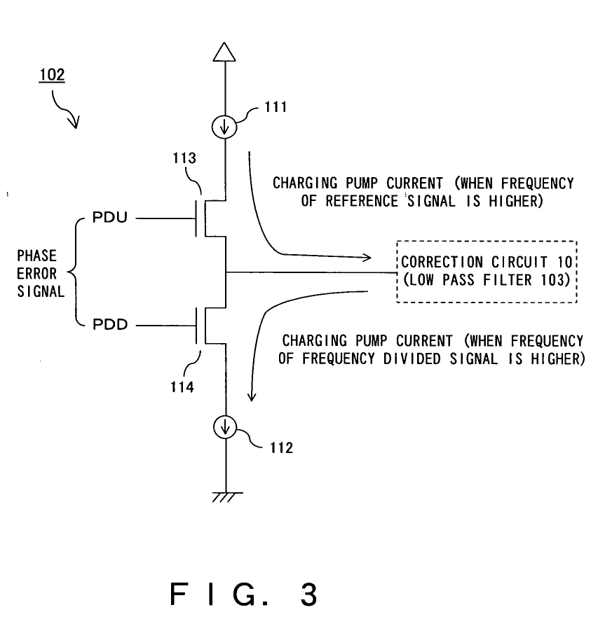

The charging pump circuit 102 comprises current sources 111 and 112 and MOS transistors 113 and 114 as shown in FIG. 3, and generates a charging pump current depending on the phase error signals PDU and PDD. If the frequency of the reference signal is higher than the frequency of the frequency divided signal, a charging pump current flowing to the low pass filter 103 is generated to raise the control voltage VT to be applied to the VCO 104. When the frequency of the frequency divided signal is higher than the frequency of the reference signal, a charging pump current flowing from the low pass filter 103 is generated to drop the control voltage VT to be applied to the VCO 104. The charging pump current is described later in detail, but is corrected by the correction circuit 10 as necessary. The low pass filter 103 has the capacitor for charged/discharged by a charging pump current (or a corrected charging pump current), and generates a control voltage VT by smoothing the charging pump current. The VCO 104 generates an output signal having the frequency depending on the control voltage VT.

The feedback system of the PLL operates such that the frequency of the frequency divided signal obtained by frequency-dividing the frequency of an output signal into 1/N matches the frequency of the reference signal. Therefore, an output signal of the PLL having a frequency N times the frequency Fref of the reference signal is generated. That is, by inputting the digital data indicating “N” as a frequency division ratio indicator signal, an output signal having a frequency N times the frequency Fref of the reference signal is generated.

The locking time of the PLL depends on the time constant of the low pass filter 103 and the charging pump current (or corrected charging pump current). The locking time is the period from the start of the operation of the PLL synthesizer or from the moment when a new frequency division ratio indicator signal is input to the time when the PLL circuit is locked. It is desired that the locking time is shorter. However, the operation of the PLL is unstable if the time constant of the low pass filter 103 is reduced or the charging pump current becomes larger to shorten the locking time. As a result, the PLL synthesizer 1 according to the present embodiment is configured such that a large current flows using the correction circuit 10 so far as an actual frequency Fout of the output signal is far from the specified frequency Fdes by a predetermined value or more when the frequency Fdes is indicated by a frequency division ratio indicator signal. Therefore, shortening the locking time of the PLL can be consistent with a stable operation after the PLL is locked.

The output signal of the PLL synthesizer 1 is generated by the VCO 104, and its frequency is indicated by the frequency division ratio indicator signal. Meantime, the frequency of the output signal of the VCO 104 uniquely depends on the control voltage VT. Thus, the control voltage VT for making the VCO 104 to generate the frequency specified by the frequency division ratio indicator signal can be estimated based on the frequency division ratio indicator signal. Thus, the correction circuit 10 monitors the control voltage VT, and locks the PLL for a short time using a large current obtained by correcting a charging pump current, when the control voltage VT is far by a predetermined value or more from a target control voltage VTo with which the frequency specified by the frequency division ratio indicator signal is to be generated by the VCO 104. In the following description, the control voltage VT with which the frequency specified by the frequency division ratio indicator signal is to be generated by the VCO 104 will be referred to as the “target control voltage VTo”.

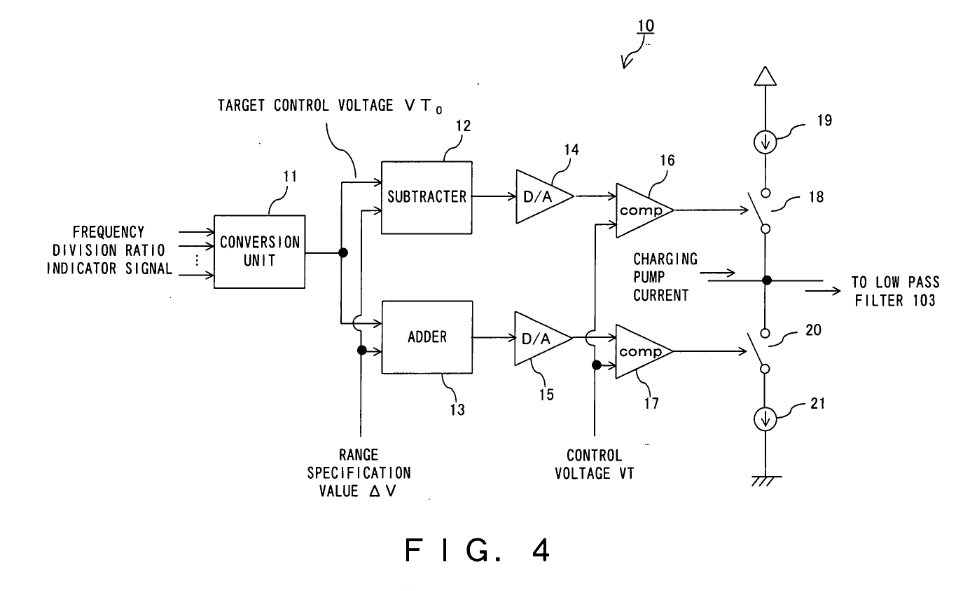

FIG. 4 shows an embodiment of the correction circuit 10. A conversion unit 11 converts a value indicated by a frequency division ratio indicator signal into digital data indicating a target control voltage VTo using a predetermined conversion expression. A subtracter 12 subtracts a range specification value ΔV from the target control voltage VTo, and an adder 13 adds the range specification value ΔV to the target control voltage VTo. D/A converters 14 and 15 respectively convert outputs of the subtracter 12 and the adder 13 to analog data. Comparators 16 and 17 respectively compare the outputs of the D/A converters 14 and 15 with the control voltage VT. The outputs of the D/A converters 14 and 15 are respectively “VTo−ΔV” and “VTo+ΔV”. The control voltage VT is an output of the low pass filter 103.

The comparator 16 outputs a signal to turn ON a switch 18 only when the control voltage VT is smaller than “the target control voltage VTo−ΔV”. When the switch 18 enters the ON state, a correction current generated by a constant current source 19 is supplied to the low pass filter 103. That is, in this case, the low pass filter 103 receives the charging pump current generated by the charging pump circuit 102 and the correction current generated by the constant current source 19. Therefore, the control voltage VT can rise by a much larger current than by the charging pump current only.

The comparator 17 outputs a signal to turn ON a switch 20 only when the control voltage VT is larger than “the target control voltage VTo+ΔV”. When the switch 20 enters the ON state, a correction current generated by a constant current source 21 is pulled from the low pass filter 103. That is, in this case, in addition to the charging pump current generated by the charging pump circuit 102, the correction current generated by the constant current source 21 pulls from the low pass filter 103, thereby quickly dropping the control voltage VT by a much larger current than by the charging pump current only.

Thus, in the correction circuit shown in FIG. 4, the charging pump current is corrected by the correction circuit 10 when the control voltage VT is out of the range of “the target control voltage VTo±ΔV”, and the control voltage VT is controlled by the larger current such that the control voltage VT can approach the target control voltage VTo. Therefore, the locking time of the PLL can be shortened.

If the frequency specified by a user is close to the actual output frequency immediately after starting the operation of the PLL circuit, then a large charging pump current is not required or it is necessary to provide a large charging pump current only for a short time. Meantime, if the frequency specified by a user is quite different from the actual output frequency immediately after starting the operation of the PLL circuit, then it is necessary to provide a large charging pump current for a longer time. Therefore, although the PLL synthesizer is designed to shorten the locking time by enlarging the charging pump current at the initial operation, a large charging pump current flows for a too long or too short time depending on the relationship between the user-specified frequency and the actual frequency of the initial state if a large current is simply provided to the low pass filter 103 for a predetermined time after starting the operation. However, the PLL synthesizer 1 according to an embodiment of the present invention estimates the target control voltage based on the frequency division ratio indicator signal, and provides a large current only in a period before the difference between the actual control voltage and the target control voltage becomes smaller than a predetermined value (ΔV in this example). As a result, the large current is provided only in a necessary period.

Then, if the control voltage VT enters the range of the “the target control voltage VTo±ΔV”, the correcting process by the correction circuit 10 stops, and the control voltage VT slowly converges into the target control voltage VTo only by the charging pump current generated by the charging pump circuit 102. Afterwards, the operation of the PLL never becomes unstable.

The intensity of the correction current generated by the constant current sources 19 and 21 is appropriately determined within a range in which the locking time of the PLL sufficiently shortened and the amplitude of the oscillation generated in the converging process of the control voltage VT, while the time constant of the low pass filter 103 is taken into account. The range specification value ΔV defines the voltage width between the upper threshold and the lower threshold for determining the necessity of a correction current. That is, if it is too large, the effect of shortening the locking time is reduced, and if it is too small, the PLL becomes unstable. Therefore, it is to be appropriately determined with all the above-mentioned factors taken into account. In the embodiment, the “voltage range setting unit” described in the claims for the patent corresponds to the conversion unit 11, the subtracter 12, and the adder 13, the “determination unit” corresponds to the comparators 16 and 17, and the “current generation unit” corresponds to the switches 18 and 20 and the constant current sources 19 and 21.

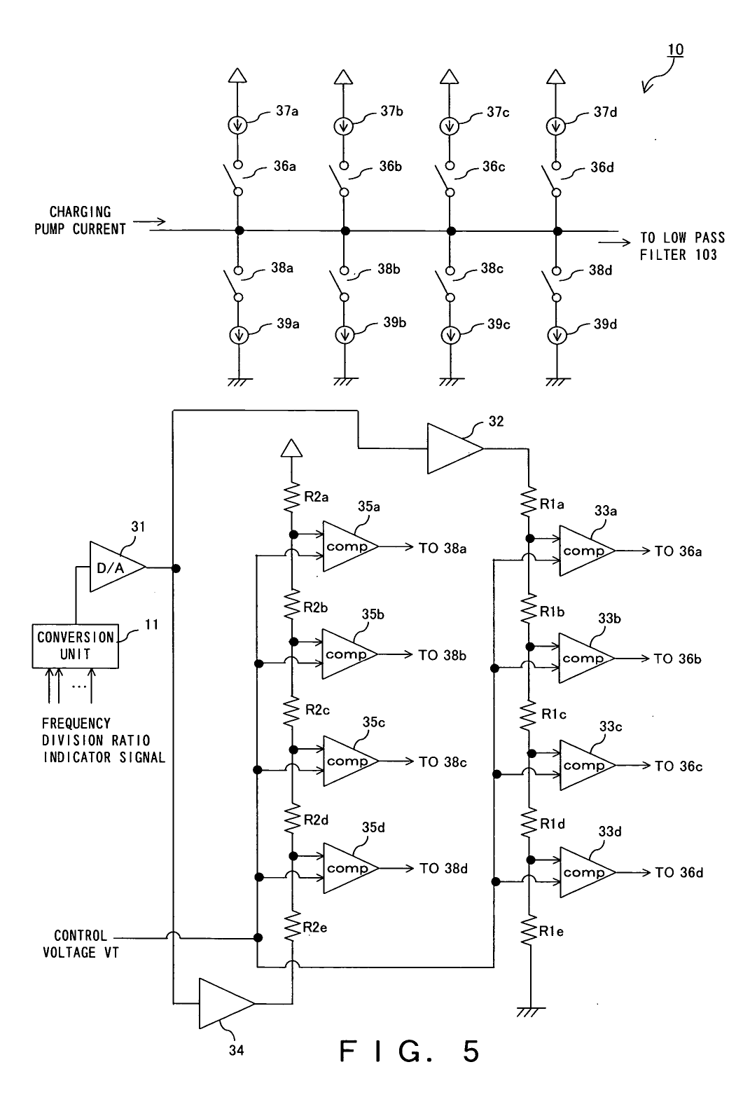

FIG. 5 shows another embodiment of the correction circuit 10. This correction circuit is configured such that the current to be supplied to the low pass filter 103 or the current to be pulled therefrom can be stepwise decreased as the control voltage VT approaches the target control voltage VTo.

The conversion unit 11 converts the frequency division ratio indicator signal into digital data indicating the target control voltage Vto, as explained above by referring to FIG. 4. A D/A converter 31 converts the output of the conversion unit 11 to analog data. The analog data indicating the target control voltage VTo is supplied to comparators 33a-33d through a buffer 32, and supplied to comparators 35a-35d through a buffer 34.

The input side of the comparators 33a-33d, resistor circuit R1a-R1e for sequentially subtracting the range specification value ΔV from the target control voltage VTo is provided. Thus, the input terminals of the comparators 33a, 33b, 33c, and 33d are respectively provided with “VTo−ΔV”, “VTo−2ΔV”, “VTo−3ΔV”, and “VTo−4ΔV” as threshold voltages. The other terminals of the comparators 33a-33d are respectively provided with the control voltage VT. Each of the comparators 33a-33d outputs a signal to turn ON corresponding switches 36a-36d when the control voltage VT is lower than the corresponding threshold voltage.

When the switches 36a-36d enter the ON state, the correction current generated by corresponding constant current sources 37a-37d is supplied to the low pass filter 103. That is, in this case, since the correction current is also supplied in addition to the charging pump current generated by the charging pump circuit 102 to the low pass filter 103, the control voltage VT can be quickly raised by a larger current than by the charging pump current only.

When the control voltage VT is lower than the threshold voltage “VTo−4ΔV”, all the switches 36a-36d are controlled to enter the ON state, and the correction currents generated by the four constant current sources 37a-37d are added to the charging pump current. Similarly, the correction currents generated by the three constant current sources 37a-37c are added to the charging pump current when “VTo−4ΔV≦VT<VTo−3ΔV”, the correction currents generated by the two constant current sources 37a-37b are added to the charging pump current when “VTo−3ΔV≦VT<VTo−2ΔV”, and only the correction current generated by the one constant current source 37a is added to the charging pump current when “VTo−2ΔV≦VT<VTo−ΔV”. Thus, the correction current to be added to the charging pump current is stepwise adjusted depending on the difference between the control voltage VT and the target control voltage VTo.

Similarly, at the input side of the comparators 35a-35d, resistor circuits R2a-R2e for sequentially adding the range specification value ΔV to the target control voltage Vto is provided. Thus, “VTo+4ΔV”, “VTo+3ΔV”, “VTo+2ΔV”, and “VTo+ΔV” are respectively supplied as threshold voltages to the input terminals of the comparators 35a, 35b, 35c, and 35d. Each of the comparators 35a-35d output the signals to turn ON corresponding switches 38a-38d when the control voltage VT is higher than the corresponding threshold voltage.

When the switches 38a-38d enter the ON state, the correction currents generated by corresponding constant current sources 39a-39d are pulled from the low pass filter 103. That is, in this case, since the correction currents in addition to the charging pump current generated by the charging pump circuit 102 are pulled from the low pass filter 103, the control voltage VT can be quickly dropped by a larger current than the charging pump current only. As described above, the intensity of the total correction current is stepwise adjusted depending on the difference between the control voltage VT and the target control voltage VTo.

Thus, according to the correction circuit shown in FIG. 5, as the difference between the control voltage VT and the target control voltage VTo decreases, the current to be supplied to the low pass filter 103 or the current to be pulled therefrom stepwise decreases. Therefore, the control voltage VT does not suddenly change in addition to the effect by the correction circuit shown in FIG. 4.

In the embodiment above, the threshold voltage changes at a constant rate. However, the present invention is not limited to the embodiment, but the changing step can be larger as the difference from the target control voltage VTo gets larger. In this embodiment, the “voltage range setting unit” described in the claims for the patent corresponds to the conversion unit 11, the resistor circuits R1a through R1e and R2a through R2e, the “determination unit” corresponds to the comparators 33a through 33d and 35a through 35d, and the “current generation unit” corresponds to the switches 36a through 36d and 38a through 38d, and the constant current sources 37a through 37d and 39a through 39d.

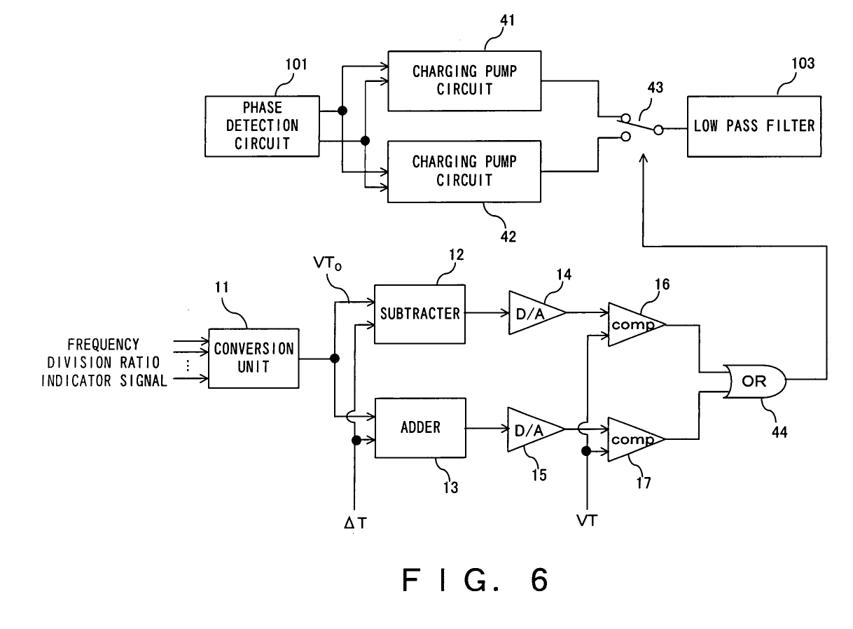

In the above-mentioned embodiment, the charging pump current generated by the charging pump circuit 102 is adjusted as necessary. However, the present invention is not limited to the embodiment. That is, for example, as shown in FIG. 6, a plurality of charging pump circuits (in this embodiment, charging pump circuits 41 and 42) are connected to the phase detection circuit 101 in parallel, and one of the charging pump circuits 41, 42 may be selected and connected to the low pass filter 103 by the switch 43. The switch 43 is controlled by the logical sum of the outputs of the comparators 16 and 17 obtained by an OR circuit 44. The charging pump current generated by the charging pump circuit 41 is larger than the charging pump current generated by the charging pump circuit 42. In this case, when the control voltage VT is out of the range of “the target control voltage VTo±ΔV”, the charging pump circuit 41 is selected. If the control voltage VT is in the range of “the target control voltage VTo±ΔV”, the charging pump circuit 42 is selected. With this configuration, the effect similar to that of the configuration shown in FIG. 2 is expected.

1. A PLL synthesizer, comprising:
a voltage control oscillator generating a signal at a frequency depending on a control voltage;
a frequency divider frequency-dividing an output signal of said voltage control oscillator according to a frequency division ratio indicator signal;
a phase detection circuit for generating a phase error signal indicating a phase difference between a reference signal at a predetermined frequency and output of said frequency divider;
a charging pump circuit generating a charging pump current according to the phase error signal;
a filter generating the control voltage from said charging pump current; and
a correction circuit correcting the charging pump current based on a difference between the control voltage and a target control voltage depending on the frequency division ratio indicator signal.

2. The PLL synthesizer according to claim 1, wherein
said correction circuit comprises:
a voltage range setting unit setting a predetermined voltage range including the target control voltage depending on the frequency division ratio indicator signal;
a determination unit determining whether or not the control voltage is within the voltage range; and
a current generation unit generating a correction current for correction of the charging pump current only when the control voltage is not within the voltage range.

3. The PLL synthesizer according to claim 2, wherein:
said voltage range setting unit sets a plurality of voltage ranges; and
said current generation unit generates a larger current with an expanding voltage range.

4. A PLL synthesizer, comprises:
a voltage control oscillator generating a signal at a frequency depending on a control voltage;
a frequency divider frequency-dividing an output signal of said voltage control oscillator according to a frequency division ratio indicator signal;
a phase detection circuit generating a phase error signal indicating a phase difference between a reference signal at a predetermined frequency and output of said frequency divider;
a first charging pump circuit generating a first charging pump current according to the phase error signal;
a second charging pump circuit, provided parallel to said first charging pump circuit, for generating a second charging pump current smaller than the first charging pump current according to the phase error signal;
a switch selecting said first charging pump circuit when a difference between the control voltage and a target control voltage depending on the frequency division ratio indicator signal is larger than a predetermined value, and selecting said second charging pump circuit when the difference between the control voltage and the target control voltage is smaller than the predetermined value; and
a filter generating the control voltage from a charging pump current generated by a charging pump circuit selected by said switch.
